(19) United States
(12) Patent Application Publication
(10) Pub. No.: US 2009/0056870 A1
(43) Pub. Date: Mar. 5, 2009

(54) Method of reinforcing a seam

(75) Inventor: Robert Arthur Glenn, Loughborough (GB)

Correspondence Address: MORGAN LEWIS & BOCKIUS LLP, 1111 PENNSYLVANIA AVENUE NW, WASHINGTON, DC, 20004, US

(73) Assignee: Stretchline Intellectual Properties Ltd.

(21) Appl. No.: 11/896,338

(22) Filed: Aug. 31, 2007

(51) Int. Cl. B29C 65/54; B32B 23/00

(52) U.S. Cl. 156/304.7; 428/192

(57) ABSTRACT

A method of reinforcing a seam in a garment or other textile article includes the step of adhering a layer of substantially unidirectionally extensible elastic material along the length of the seam such that the material straddles the seam and the direction of extensibility of the material is generally aligned with the elongate direction of the seam.

### SUMMARY OF THE INVENTION

The invention relates to a method of reinforcing a seam particularly, but not exclusively, in shape-conforming garments or other textile articles produced from stretchable textile materials such as football shirts, swimwear, body suits and control briefs.

During the manufacture of garments and other textile articles it is often necessary to secure together the edges of two or more layers of textile material, which results in the formation of a seam between the layers of textile material.

In shape-conforming garments, such as undergarments and other close-fitting garments, it is becoming increasingly desirable to minimize the appearance of seams at the juncture between layers of textile material and thereby create a garment having a “seamless” appearance.

One method of creating a relatively discrete seam at the juncture between layers of textile material involves the use of an ultrasonic bonding assembly, which is suitable for creating a bond between layers of synthetic textile materials or textile materials containing thermoplastic yarns.

In an ultrasonic bonding assembly, two or more layers of suitable textile material are passed between a vibrating horn and an anvil, which often takes the form of a rotary drum made from hardened steel and machined to create a pattern of raised areas where bonding takes place. Typically a transducer containing piezoelectric crystals converts high frequency electrical signals to mechanical vibration, typically having a frequency of about 35 kHz, which is transmitted to the horn.

Friction that occurs through contact between the vibrating horn and the raised areas on the surface of the anvil, via the layers of textile material, results in the localized generation of heat. The heat that is generated softens the synthetic or thermoplastic fibers in the layers of textile material and, together with a compressive force applied by the horn against the anvil, results in the layers of textile materials becoming bonded to one another.

Such bonding is localized to the points at which the drum and anvil are brought into contact via the layers of textile material. In a seaming operation therefore the resultant bond may be created so as to minimize the bulk and therefore appearance of the seam.

As with other forms of creating a seam at the juncture between two or more layers of textile material, it is important that the seams created using an ultrasonic bonding assembly are able to withstand tensile loads during use. There is otherwise a risk the seams will fail when the layers of textile material are pulled away from each other. This is particularly important in shape-conforming garments or other textile garments produced from stretchable textile materials in which relatively significant loads may be applied to seams created at the junctures between layers of textile material.

Conventional methods of strengthening seams, using additional lines of stitching for example, result in the creation of bulky seam structures and are not therefore suitable for use in the manufacture of garments having a “seamless” appearance.

According to a first aspect of the invention there is provided a method of reinforcing a seam in a garment or other textile article comprising the step of adhering a layer of substantially unidirectionally extensible elastic material along the length of the seam such that the said material straddles the seam and the direction of extensibility of the said material is generally aligned with the elongate direction of the seam.

This method results in a reinforced structure in which the seam is protected from loads that would otherwise have a tendency to pull apart the layers of textile material secured to other another along the seam whilst at the same time allowing the layers of textile material to stretch in the elongate direction of the seam.

The method also provides a means of reinforcing a seam without unnecessarily increasing the bulk of the seam itself. It is therefore particularly advantageous when used in garments or other textile articles in which it is desirable to minimize the appearance of seams.

As well as serving to maintain the integrity of the seam, the provision of a layer of material adhered along the length of the seam results, through an appropriate choice of material, in a structure that may be utilized to provide a decorative effect on an exterior surface of a garment or to improve comfort on an inner surface of a garment that is intended to be worn in direct contact with a wearer's skin by forming an intermediate layer between the seam and the wearer's skin.

The substantially unidirectionally extensible elastic material preferably comprises a strip of an elastic fabric containing lengthwise extending elastomeric yarns incorporated so as to permit extension of the strip in a lengthwise direction whilst resisting deformation of the strip in a widthwise direction when the strip is adhered along the length of the seam.

In particular, the elastic fabric may be a woven or knitted fabric containing elastomeric warp yarns and substantially non-extensible weft yarns so as to permit extension of the fabric in a warpwise direction and resist extension of the fabric in a weftwise direction when the strip is adhered along the length of the seam.

In order to ensure that the substantially unidirectionally extensible elastic material does not inhibit any stretch in an elongate direction, and thereby further minimize the appearance of a seam, the elastic material is preferably chosen such that it exhibits substantially the same recoverable extension as the seam in an elongate direction on the application of a tensile load.

In this regard, substantially the same recoverable extension is preferably 70-130%, more preferably 90-110%, most preferably 95-105% and especially 100% of the recoverable extension in the elongate direction on the application of a tensile load.

In preferred embodiments, the substantially unidirectionally extensible elastic material is adhered along the length of the seam using a hot melt adhesive, which may be applied directly to the surface of the elastic material in the form of a uniform pattern, or may be fed between the elastic material and the seam in the form of a continuous film.

A flat fusing press or heated rollers through which the elastic material and seam are fed may be used to melt the hot melt adhesive and thereby create the adhesive bond between the elastic material and the seam.

The use of a hot melt film such as, for example a hot melt polyurethane film, ensures that the elastic material is adhered over its entire surface to the seam and the textile material on either side of the seam.

In other embodiments where the substantially unidirectionally extensible elastic material is a woven or knitted fabric, the elastic fabric may be adhered along the length of the seam by means of fusible yarns, such as for example Grilon® yarns, woven or knit into the elastic fabric.

Again, in such embodiments, a flat fusing press or heated rollers through which the elastic material and seam are fed may be used to melt the fusible yarns and thereby create the adhesive bond between the elastic material and the seam.

It is also envisaged that in yet further embodiments, a pressure adhesive may be used to adhere the elastic material along the length of the seam. In such embodiments a flat press or rollers may be used to create the adhesive bond between the elastic material and the seam.

In order to produce a ruched effect along at least part of the length of the seam, the substantially unidirectionally extensible elastic material may be adhered under tension along the length of the seam.

According to a second aspect of the invention there is provided a method of producing a reinforced seam in a garment or other textile article comprising the steps of:

(a) securing the edges of two or more layers of textile material together to form a seam;

(b) adhering a layer of substantially unidirectionally extensible elastic material along the length of the seam such that the said material straddles the seam and the direction of extensibility of the said material is generally aligned with the elongate direction of the seam.

Preferably, in order to minimize the bulk of the seam, the method further comprises the steps of removing excess textile material following formation of the seam and laying the seam flat prior to adherence of the substantially unidirectionally extensible elastic material along the length of the seam.

As will be appreciated by those skilled in the art, the edges of the two or more layers of textile material may be secured together by means of stitching, ultrasonic bonding, adhesive bonding or a combination of one or more such methods.

In embodiments where the layers of textile material contain synthetic or thermoplastic yarns and the edges of two or more such layers of textile material are secured together by means of ultrasonic bonding, the excess textile material may be performed simultaneously using ultrasonics. This arrangement not only improves the efficiency of the production of the seam, but leads to the creation of sealed edges along the seam, which are resistant to fraying and therefore improves the integrity of the seam while at the same time minimizing its bulk.

According to a third aspect of the invention there is provided a reinforced seam in a garment or other textile article comprising the edges of two or more layers of textile fabric secured together and a layer of substantially unidirectionally extensible elastic material adhered along the length of the seam such that the said material straddles the seam and the direction of extensibility of the said material is generally aligned with the elongate direction of the seam.

Other advantageous features of the invention are recited in the claims.

### BRIEF DESCRIPTION OF THE DRAWINGS

An embodiment of the invention will now be described, by way of a non-limiting example, with reference to the figures in which:

FIG. 1 provides a schematic illustration of formation of a seam along a juncture between two layers of textile material during the production of a reinforced seam in accordance with an embodiment of the invention;

FIG. 2 provides a schematic illustration of adherence of a strip of elastic fabric along the length of the seam during the production of the reinforced seam; and

FIG. 3 provides a schematic illustration of a cross-sectional view of the reinforced seam.

### DETAILED DESCRIPTION OF THE INVENTION

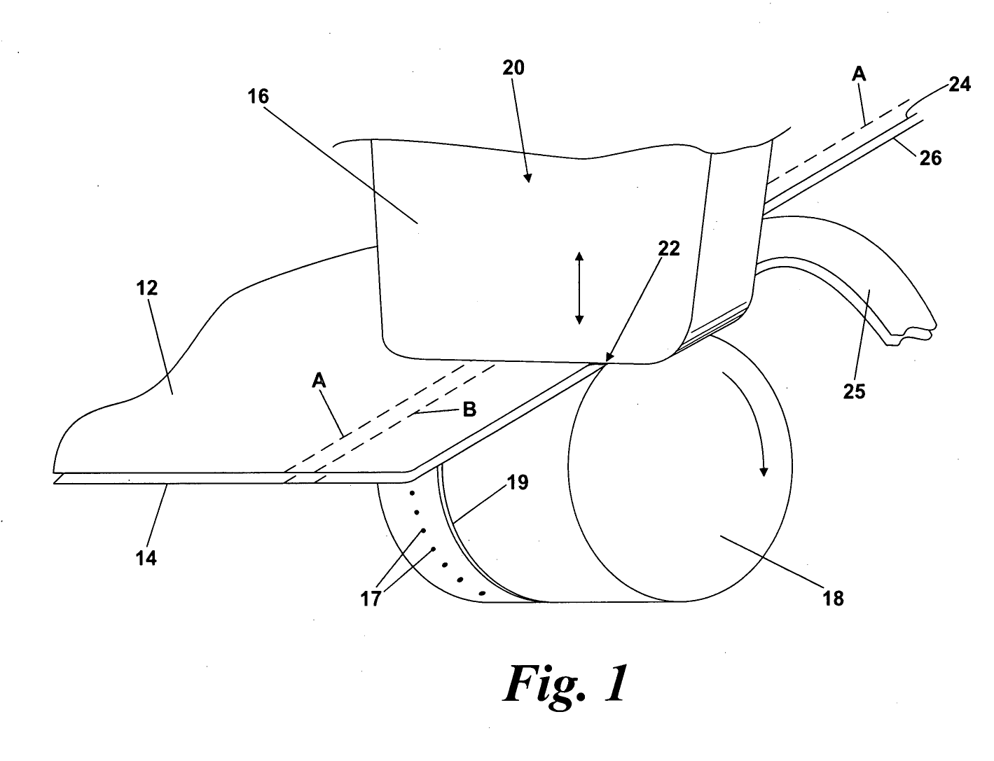

A method of producing a reinforced seam 10, in accordance with an embodiment of the invention, will be described with reference to FIGS. 1-3.

The formation of a seam 10 between two layers of synthetic textile fabric 12, 14 is illustrated in FIG. 1.

The layers of synthetic textile fabric 12,14 include synthetic yarns and are arranged initially in face to face contact such that edges thereof are aligned and can be passed between a nip 22 created between a horn 16 and anvil 18 of an ultrasonic bonding assembly 20. The anvil 18 is provided in the form of a rotary drum to draw the layers of synthetic textile fabric 12, 14 through the nip 22.

During use of the ultrasonic bonding assembly 20 the horn 16 is driven to vibrate at a frequency of approximately 35 kHz thereby bringing the vibrating horn 16 into contact with raised areas 17 provided on the surface of the rotary drum, via the layers of synthetic textile fabric 12, 14.

Friction resulting from the contact of the vibrating horn 16 against the raised areas 17 on the anvil 18 results in localized heating of the layers of synthetic fabric 12,14 as they are drawn through the nip 22. This results in the softening of the thermoplastic yarns in the layers of synthetic fabric 12, 14 at the points of contact between the layers of fabric 12, 14 and the raised areas 17.

The pattern of the raised areas 17 on the surface of the rotary drum forming the anvil 18 is chosen such that during passage of the layers of synthetic textile fabric 12,14 through the nip 22, thermoplastic yarns in the layers 12,14 are softened along a seam line A.

Compression of the layers 12, 14 along the seam line A by virtue of the nip 22 created between the vibrating horn 16 and the anvil 18, followed by cooling of the heated thermoplastic yarns once the layers 12, 14 pass through the ultrasonic bonding assembly 20, results in the formation of a bond between the layers 12, 14 along the seam line A and thereby results in the formation of a seam 10.

The rotary drum is also formed to define a cutting edge 19 that contacts the vibrating horn 16 via the layers of synthetic textile fabric 12, 14 as they are drawn through the nip 22. The cutting edge 19 is provided on the rotary drum so as to contact the vibrating horn 16 via the layers 12, 14 along a cut line B and thereby simultaneously cut the layers 12, 14 along the cut line B during the formation of the bond along the seam line A, which results in the removal of excess fabric 25 from the layers 12, 14.

Friction created through contact of the cutting edge with the vibrating horn 16 creates localized heating of thermoplastic yarns along the cut line B in the layers of synthetic textile fabric 12,14, which results in the formation of fused edges 24,26 along the cut line B following removal of the excess fabric 25 from the layers 12,14.

In other embodiments it is envisaged that the layers of textile fabric 12, 14 may be secured together to form a seam 10 through the use of a conventional sewing machine to create a line of stitching along seam line A, or through the use of hot melt adhesive in combination with a flat fuse press or heated rollers to adhere the layers 12, 14 together along seam line A.

It is also envisaged that in other embodiments the excess fabric may be removed using a cutting assembly, in a separate step, following creation of the seam 10 along seam line A.

Following creation of the seam 10 along seam line A, and removal of excess fabric 25, the layers of textile fabric 12, 14 are unfolded about the seam 10 so as to lay the seam 10 flat.

A layer of substantially unidirectionally extensible elastic material is then adhered along the length of the seam 10 such that the material straddles the seam 10 and the direction of extensibility of the material is generally aligned with the elongate direction C of the seam 10.

In the embodiment described with reference to FIGS. 1-3, the layer of substantially unidirectionally extensible elastic material is provided in the form of a strip 30 having a width W that is greater than the width w of the seam 10.

The strip 30 is preferably formed from a woven or knitted fabric containing elastomeric warp yarns and substantially non-extensible weft yarns that permit extension of the fabric in the warpwise direction and resist extension of the fabric in the weftwise direction.

The elastic fabric is preferably chosen such that the fabric exhibits substantially the same recoverable extension as the seam 10 in an elongate direction on the application of a tensile load.

In this regard, substantially the same recoverable extension is preferably 70-130%, more preferably 90-110%, most preferably 95-105% and especially 100% of the recoverable extension in the elongate direction on the application of a tensile load.

An elastic fabric that satisfies such parameters may be selected by applying a tensile load to the seam 10 to determine the resultant, recoverable extension in an elongate direction of the seam 30. An elastic fabric that demonstrates substantially the same recoverable extension in an elongate direction when the same tensile load is applied may then be selected.

In the embodiment described with reference to FIGS. 1-3, the strip 30 is adhered along the length of the seam 10 using a continuous film 32 of hot melt adhesive such as, for example, a hot melt polyurethane film.

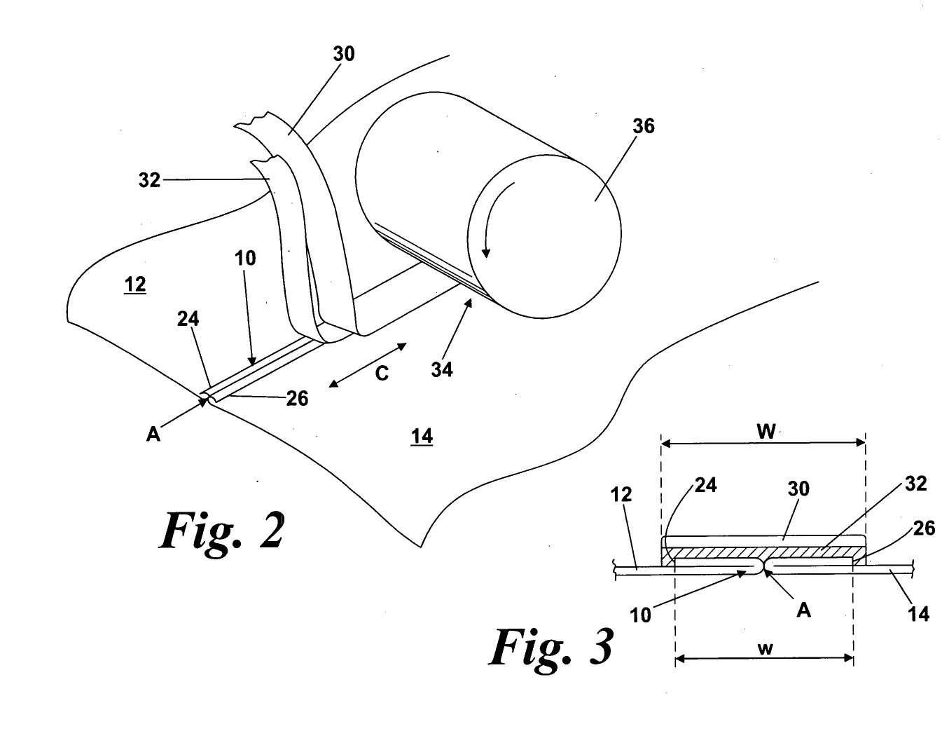

The film 32 of hot melt adhesive is fed between the strip 30 and the seam 10 as the strip 30 and the seam 10 are fed through a nip 34 created between a pair of heated rollers 36, only one of which is shown in FIG. 2.

Preferably one or both of the heated rollers 36 is driven to rotate and thereby draw the sandwich of seam 10, film 32 and strip 30 through the nip 34, during which time the heated rollers 36 heat the film 32 through the strip 30 and the seam 10 and cause the film 32 to melt and adhere the strip 30 along the length of the seam 10.

In other embodiments it is envisaged that the film 32 of hot melt adhesive may be replaced by hot melt adhesive provided directly onto the surface of the strip 30 intended to be adhered along the length of the seam 10, thereby avoiding the need to feed the film 32 between the seam 10 and the strip 30 during their passage through the nip 34 between the heated rollers 36.

In further embodiments it is envisaged that the strip 30 and seam 10, together with hot melt adhesive in the form of a film 32 or provided on the surface of the strip 30, may be located within a flat fuse press to heat and melt the hot melt adhesive and thereby produce the required bond between the strip 30 and the seam 10.

In yet further embodiments it is envisaged that the strip 30 may be adhered along the length of the seam 10 by means of fusible yarns, such as for example Grilon® yarns, woven or knit into the strip 30. In such embodiments a flat fusing press or heated rollers may be used to melt the fusible yarns and thereby create the adhesive bond between the strip 30 and the seam 10.

In yet further embodiments it is envisaged that a pressure adhesive may be provided between the strip 30 and the seam 10, either provided directly onto the surface of the strip 30 or in the form of a continuous film 32 located between the strip 30 and the seam 10, to adhere the strip 30 along the length of the seam 10. Again in such embodiments a flat press or rollers may be used to create the adhesive bond between the elastic material and the seam.

The width W of the strip 30 and the width w of the seam 10 is such that following adherence of the strip 30 along the length of the seam 10, the strip 30 is adhered to the layers of textile fabric 12,14 on each side of the seam 10 (FIG. 3).

The inextensibility of the strip 30 in a widthwise direction results in a structure in which the seam 10 is protected from loads that would otherwise have a tendency to pull apart the layers of textile material 12, 14 along the seam 10.

The extensibility of the strip 30 in the lengthwise direction however permits the strip 30 to stretch with the layers of textile material 12, 14 when they are stretched in the elongate direction C of the seam 10. In embodiments where the strip 30 is formed from an elastic fabric that exhibits substantially the same recoverable extension as the seam 10 in an elongate direction on the application of a tensile load, the effect of the strip 30 on the stretch of the seam 10 in an elongate direction is therefore negligible.

Depending on the material chosen to form the strip 30, the strip 30 may provide a decorative effect along the seam 10 for location on an outer surface of a garment or other textile article, or may improve comfort on an inner surface of a garment that is intended to be worn in direct contact with a wearer's skin by forming an intermediate layer between the seam 10 and the wearer's skin.

It is envisaged that the method of the invention may be used to create a curved seam. In such embodiments, the width W of the strip 30 to be adhered along the length of the seam 10 is preferably chosen so as to be only marginally greater than the width w of the seam 10. While this arrangement results in minimal contact area between the strip 30 and the layers of textile fabric 12, 14 on each side of the seam 10, it assists in minimizing the effect of the strip 30 on the stretch of the textile fabric 12, 14 along the seam 10.

In yet further embodiments it is envisaged that the strip 30 may be adhered under tension along at least part of the length of the seam 10. On release of the tension in the strip 30, this would result in a ruched effect along the length of at least part of the seam 10.

1. A method of reinforcing a seam in a garment or other textile article comprising adhering a layer of substantially unidirectionally extensible elastic material along a length of the seam such that the material straddles the seam and a direction of extensibility of the material is generally aligned with the elongate direction of the seam, wherein
the material exhibits substantially the same recoverable extension as the seam in an elongated direction on the application of a tensile load.

2. The method of reinforcing a seam according to claim 1 wherein the material comprises a strip of an elastic fabric containing lengthwise extending elastomeric yarns incorporated so as to permit extension of the strip in a lengthwise direction while resisting deformation of the strip in a widthwise direction when the strip is adhered along the length of the seam.

3. The method of reinforcing a seam according to claim 2 wherein the elastic fabric is a woven or knitted fabric containing elastomeric warp yarns and substantially non-extensible weft yarns so as to permit extension of the fabric in a warpwise direction and resist extension of the fabric in a weftwise direction when the strip is adhered along the length of the seam.

4. The method of reinforcing a seam according to claim 1 wherein the material is adhered along the length of the seam using a hot melt adhesive.

5. The method of reinforcing a seam according to claim 3 wherein the elastic fabric is adhered along the length of the seam using fusible yarns woven or knit into the elastic fabric.

6. The method of reinforcing a seam according to claim 1 wherein the material is adhered under tension along at least part of the length of the seam.

7. A method of producing a reinforced seam in a garment or other textile article comprising:
(a) securing edges of two or more layers of textile material together to form a seam; and
(b) adhering a layer of substantially unidirectionally extensible elastic material along a length of the seam such that the material straddles the seam and the direction of extensibility of the material is generally aligned with the elongate direction of the seam, wherein
the material exhibits substantially the same recoverable extension as the seam in an elongated direction on the application of a tensile load.

8. The method of producing a reinforced seam according to claim 7 further comprising removing excess textile material following formation of the seam and laying the seam flat prior to adherence of the material along the length of the seam.

9. The method of producing a reinforced seam according to claim 7 wherein the edges of two or more layers of textile material are secured together by means of one or more of stitching, ultrasonic bonding and adhesive bonding.

10. The method of producing a reinforced seam according to claim 8 wherein the two or more layers of textile material contain synthetic fibers and the steps of securing the edges of the two or more layers of textile material to form the seam and removing excess textile material are performed simultaneously using ultrasonics.

11. The method of producing a reinforced seam according to claim 7 wherein the material comprises a strip of an elastic fabric containing lengthwise extending elastomeric yarns incorporated so as to permit extension of the strip in a lengthwise direction while resisting deformation of the strip in a widthwise direction when the strip is adhered along the length of the seam.

12. The method of producing a reinforced seam according to claim 11 wherein the elastic fabric is a woven or knitted fabric containing elastomeric warp yarns and substantially non-extensible weft yarns so as to permit extension of the fabric in a warpwise direction and resist extension of the fabric in a weftwise direction when the strip is adhered along the length of the seam.

13. (canceled)

14. The method of producing a reinforced seam according to claim 7 wherein the material is adhered along the length of the seam using a hot melt adhesive.

15. The method of producing a reinforced seam according to claim 7 wherein the elastic fabric is adhered along the length of the seam using fusible yarns woven or knit into the elastic fabric.

16. The method of producing a reinforced seam according to claim 7 wherein the material is adhered under tension along at least a part of the length of the seam.

17. A reinforced seam in a garment or other textile article comprising edges of two or more layers of textile fabric secured together and a layer of substantially unidirectionally extensible elastic material adhered along a length of the seam such that the material straddles the seam and the direction of extensibility of the material is generally aligned with an elongate direction of the seam, wherein
the material exhibits substantially the same recoverable extension as the seam in an elongated direction on the application of a tensile load.

18. The reinforced seam according to claim 17 wherein edges of two or more layers of textile material are secured together by means of one or more of stitching, ultrasonic bonding and adhesive bonding.

19. The reinforced seam according to claim 18 wherein the two or more layers of textile material contain synthetic fibers and the edges of the two or more layers of textile material are secured together by means of ultrasonic bonding.

20. The reinforced seam according to claim 17 wherein the material comprises a strip of an elastic fabric adhered along the length of the seam, the elastic fabric containing lengthwise extending elastomeric yarns incorporated so as to permit extension of the strip in a lengthwise direction whilst resisting deformation of the strip in a widthwise direction.

21. The reinforced seam according to claim 17 wherein the elastic fabric is a woven or knitted fabric containing elastomeric warp yarns and substantially non-extensible weft yarns so as to permit extension of the fabric in a warpwise direction and resist extension of the fabric in a weftwise direction.

22. (canceled)

23. The reinforced seam according to claim 17 wherein the material is adhered along the length of the seam using a hot melt adhesive.

24. A reinforced seam according to claim 21 wherein the elastic fabric is adhered along the length of the seam using fusible yarns woven or knit into the elastic fabric.

25. The reinforced seam according to claim 17 wherein the material is adhered under tension along at least part of the length of the seam forming a ruched seam.
